(19) United States
(12) Patent Application Publication
(10) Pub. No.: US 2024/0207939 A1
(43) Pub. Date: Jun. 27, 2024

(54) METHOD AND DEVICE FOR REMOVING SUPPORTING STRUCTURES FROM AN OBJECT

(71) Applicant: Gerald RESCH, St. Stefan i.R. (AT)

(72) Inventor: Gerald RESCH, St. Stefan i.R. (AT)

(21) Appl. No.: 18/557,009

(22) PCT Filed: May 5, 2022
(86) PCT No.: PCT/AT2022/060156

§ 371 Date: Oct. 24, 2023

(30) Foreign Application Priority Data
May 7, 2021 (AT) A 50353/2021

(51) Int. Cl. B22F 10/40; B22F 10/66; B33Y 40/20

(52) U.S. Cl. CPC B22F 10/40; B22F 10/66; B22F 2202/01; B33Y 40/20

(57) ABSTRACT

A method of removing supporting structures from an object produced by an additive manufacturing process is presented, in which a supporting structure is provided between a target structure and a base plate and has a connection thereto, and one of the connections is released by excitation using mechanical vibrations. To enable a more efficient and safer removal of the supporting structures without damaging the elements of the object themselves, by way of the use of an actuator coupled to the target structure or an intermediate element, one mechanical excitation vibration is introduced and is excited with a resonance vibration in order to release the one connection in that the deflection of the resonance vibration exceeds the load limit of the supporting structure.

The invention relates to a method and a device for removing supporting structures from an object which has been produced by an additive manufacturing process and in which at least one supporting structure is provided between a first element and a second element of the object and has, in each case, at least one connection thereto and in which the supporting structure forms a vibration system together with the first and second elements, wherein at least one of the connections is released by exciting the vibration system by means of mechanical vibrations.

Furthermore, the invention relates to a method for the production of an object by additive manufacturing, wherein the object has at least a first and a second element which are spaced apart from each other by a clearance, and wherein at least one connection between the first element or, respectively, the second element and at least one supporting structure is, in each case, provided during manufacture and wherein at least one of the connections is released following the additive manufacturing of the object by the introduction of mechanical vibrations.

### STATE OF THE ART

As part of additive manufacturing processes, such as 3D printing of synthetic materials, metals or concrete, laser sintering, deposition welding, or the like, there is often a need to provide supporting structures or auxiliary structures, for example, in order to be able to implement free-standing or overhanging structures. Without the use of appropriate supporting structures, it would not be possible, for example, to implement horizontal elements without underlying structures by means of 3D printing.

Such supporting structures or, respectively, auxiliary structures can furthermore be used for heat transfer and/or for mechanical support, stabilization or shaping, for example. In doing so, the supporting structures are usually removed as a last processing step, which, however, is often not possible or only possible to a very limited extent, especially with internal structures or very small structures.

Also for welding/deposition welding, shaping or, respectively, shape retention is occasionally enabled or, respectively, facilitated by auxiliary structures.

The importance of supporting structures is greatest in 3D printing, wherein the use of supporting structures limits the manufacturability of objects and, respectively, shapes. The profitability of 3D printing processes also depends largely on efficient removal of the supporting structures.

In 3D printing, particularly in a subsection thereof that is based on the bonding or fusing or, respectively, sintering of a material, and specifically in metal-based 3D printing, supporting structures play a particularly important role. Due to the high temperatures for locally melting the material during laser sintering, thermal stresses occur in particular in the components or, respectively, objects. For suppressing the resulting deformations, supporting structures are sometimes inevitable. On the one hand, they keep the structural components in shape and in position, on the other hand, they are indispensable for heat transport and temperature balance. However, the labour costs for removing the supporting structures typically constitute more than half of the labour costs associated with production. As a result, the profitability of such a manufacturing process is severely limited.

According to the prior art, in large-format 3D printing, especially in construction, the difficulty involved in removing auxiliary structures also plays a dominant role with regard to the manufacturing costs and the efficiency of the process.

With nano 3d printing (FEBID and FIBID), the size of the structures that can be produced is limited by a maximum overall height, which can only be increased through the use of (printed) support constructions.

From the prior art, it is known, for example, to remove such supporting structures by manual removal (e.g., by grinding, sawing, milling, melting and knocking them out, etc.). However, such a removal is associated with high costs due to the large amount of work involved. In addition, some supporting structures that are very small or are located internally or, respectively, are difficult to access can be removed manually only with great difficulty.

Methods of removing supporting structures from 3D-printed objects made of metal (“selective laser sintering”) are known from the prior art (WO 2018/093958 A1). In this case, supporting structures are used during printing in order to support free-hanging areas, for example. After printing, the objects are then ultrasonically treated using an ultrasonic device in order to remove the supporting structures, with the object being completely immersed in a liquid. In doing so, longitudinal ultrasonic waves of a specific frequency are used for removing the supporting structures, with an ultrasonic sensor being attached to the supporting structure, which ultrasonic sensor records the resonance of the supporting structure while the entire component is exposed to the ultrasonic waves. In doing so, the frequency of the ultrasonic waves is modified until the maximum resonance of the supporting structure is found, i.e., the resonance frequency of the supporting structure is reached.

Such a method, using a liquid as a transmission medium without taking further countermeasures, is afflicted with a number of disadvantages.

Above all, the liquid drastically reduces the quality of the resonance vibrations of the supporting structures through mechanical damping (the quality is thereby often reduced by a factor of over 100, oftentimes also by a factor of well over 1000). This involves decisive disadvantages when it comes to exciting the resonance vibrations. On the one hand, with steady resonance excitation, the amplitude increases to an appropriately low extent, since energy simultaneously flows out of the vibration system due to damping, which significantly reduces the efficiency of the method. On the other hand, the excitation energies required for releasing the connections and removing the supporting structures become very high, which, in turn, causes damage to other sensitive target structures.

When using ultrasound, cavitations may additionally occur, which can damage fine target structures, which reduces the usability of the method for very fine structures. Furthermore, there is only a restriction to longitudinal waves, whereby the range of excitable vibration modes is further limited.

Furthermore, the liquid can cause undesirable chemical interactions with the material of the object and can damage it. For very large parts, positioning in an appropriately large container is impractical and expensive or, respectively, even impossible.

Hence, such methods fundamentally suffer from the fact that the supporting structures can hardly be broken in a targeted and selective manner without correspondingly damaging other sensitive structures of the component itself.

### DISCLOSURE OF THE INVENTION

The present invention is based on the object of improving a method of removing supporting structures from an object which has been produced by an additive manufacturing process in such a way that efficient and safe removal of the supporting structures is rendered possible without damaging the elements of the object itself.

The invention achieves the object that has been presented by a method of removing supporting structures having the features of claim 1 and by a device having the features of claim 11. Advantageous embodiments of the invention are set forth in the dependent claims, in the specification and in the drawings.

The method according to the invention and the device according to the invention relate to the removal of supporting structures from an object which has been produced by an additive manufacturing process and in which at least one supporting structure is provided between a first element and a second element of the object and has, in each case, at least one connection thereto and in which the supporting structure forms a vibration system together with the first and second elements. According to the method, at least one of the connections is released by exciting the vibration system by means of mechanical vibrations, wherein, using at least one actuator coupled to the object, at least one mechanical excitation vibration is introduced into the latter and is supplied to the vibration system, and the vibration system is excited with at least one resonance vibration associated with it in order to release the at least one connection, with the deflection of the resonance vibration exceeding the load limit at least at one point in the vibration system at least at one point in time, the first element being a target structure or an intermediate plate and the second element of the object being a base plate of the object and the at least one actuator being coupled to the first element.

In this case, a spot of spatial extent which is part of the object and is formed in particular by a spatial arrangement or, respectively, a spatial area of related and adjacent points in the object is referred to as at least one point within the meaning of the present invention. In particular, the spot is located in a connection between a first or second element and a supporting structure. As a rule, the load limit is exceeded in an area of related points or, respectively, spots in the connection so that the connection between the supporting structure and the first or second element is completely released.

By introducing at least one mechanical excitation vibration into the object and exciting the vibration system with a resonance vibration via the excitation vibration, a high local deflection or, respectively, amplitude of the resonance vibration can be achieved in the vibration system. In particular, the frequency of the excitation vibration is thereby in the vicinity of a resonance frequency or, respectively, a natural frequency of the vibration system in order to enable efficient excitation of the resonance vibration.

By exciting the resonance vibration with an excitation frequency (frequency of the excitation vibration), which essentially corresponds to a natural frequency of the vibration system, the energy of several excitation vibrations can be collected in the resonance vibration in case of a sufficiently high quality Q or, respectively, a sufficiently low damping D. This causes an excessive increase in resonance of the resonance vibration, and very high deflections or, respectively, amplitudes can be achieved. As a result of the fact that the energy is continuously collected from the excitation vibration, the resonance vibration preferably has the highest energy density in the entire object at the point of the connection to be released, at least at one point in time.

If the deflection or, respectively, amplitude of the resonance vibration exceeds, at one point in time, the load limit of the supporting structure in at least one point in the object, in particular in a point of the connection, a resonance catastrophe will occur as a result of the collected energy from the excitation vibration, and the at least one connection between the supporting structure and a first or second element of the object is released according to the invention.

In other words, a method of removing supporting structures from an object which has been produced using an additive manufacturing process, in particular a primary shaping process, preferably a 3D printing process, particularly preferably using a 3D printing process for metals, is thus shown, wherein the supporting structures are removed or, respectively, broken up by mechanical excitation. For this purpose, energy is supplied to the supporting structures by several actuators in the form of excitation vibrations and is collected or, respectively, stored therein, whereby the vibration amplitude in the supporting structure is increased until the supporting structure or a connection of the supporting structure breaks. According to the invention, at least one vibration parameter (deflection, energy, etc.) at least at one point of the at least one supporting structure to be broken up exceeds the corresponding value of the excitation vibration at the location of generation or coupling into the object. In this case, the excitation vibrations the energy of which is summed up can come from one or several actuators, influencing, among other things, the number of vibrations to be collected until the overload limit is reached at one point of the supporting structure.

With regard to the resonance vibration, the vibration system preferably has a quality Q that is greater than or equal to ½, in particular greater than or equal to 2, particularly preferably greater than or equal to 10.

The quality of the vibration system is crucial for the ability of the resonance vibration to collect energy from the excitation vibrations, thus leading in a locally selective manner to an excessive increase in the amplitude's resonance. In this case, the quality Q is defined via the damping D of the system as Q=½D. So that high quality is achieved in the vibration system, the vibration system must therefore exhibit a damping as low as possible. Numerous influencing factors thereby contribute to the damping of the resonance vibration, such as the medium surrounding the supporting structure, the connections between the supporting structure and the first or second element of the object, as well as other vibration systems in the object of high quality. Subsequently, the damping likewise leads to a shifting and broadening of the resonance, with the natural frequency of the resonance vibration shifting by a factor of (1−D²)^{1/2} when damped, compared to the undamped natural frequency.

According to a preferred embodiment variant of the invention, the excitation frequency of the excitation vibration is, in this case, selected such that a sufficiently good excitation of the resonance frequency of the vibration system will occur, but a resonant excitation of further vibration systems will not take place in the object.

The system comprising at least the first and second elements as well as the supporting structure to be removed in the object is referred to as a vibration system within the meaning of the invention, with the supporting structure being connected to the first and second elements by means of at least one connection each. Such a connection can be a cohesive connection, for example, as it is formed in the course of an additive manufacturing process. However, in a further embodiment variant of the invention, such a connection can also be a non-positive connection, with, for example, the supporting structure being clamped between the first and second elements, or with an element being loaded onto the supporting structure.

Structures of the object which remain in the object upon removal of all temporary elements, such as, in particular, the supporting structures, are referred to as target structures. A base plate can be, for example, a flat surface on which the object is formed and from which the object is detached upon completion or, respectively, upon implementation of the method forming the subject matter. The method according to the invention is thus suitable for a reliable and selective removal of all types of supporting structures which are temporarily provided between any elements of the object.

An intermediate element is an element which is spaced apart from the target structure and from a base plate via supporting structures.

The resonance vibration associated with the vibration system corresponds in particular to the excitation of at least one normal mode of the vibration system. In this case, the at least one normal mode of the vibration system can preferably be a deformation vibration of the supporting structure. In this connection, it is understood that a deformation vibration can be a bending vibration, a stretching vibration, a rotational vibration or the like.

In one embodiment of the method according to the invention, a single actuator is coupled to the first element and introduces a mechanical excitation vibration into the first element, by means of which it sets the first element into resonance vibration, whereupon the actuator changes the excitation vibration to a counter-vibration, thereby promoting the breakage of the supporting structure.

In a further embodiment variant of the invention, several actuators can be coupled to the first element and optionally to the second element and can introduce several mechanical excitation vibrations with different excitation frequencies. In this way, each of the excitation vibrations can excite a different resonance vibration and thus a different normal mode of the vibration system. The resonance vibrations of the vibration system thereby overlap each other to form a resulting overall vibration, which can simultaneously comprise a stretching vibration and a rotational vibration, for example. By simultaneously exciting several resonance vibrations, a more efficient release of the at least one connection of the supporting structure can be achieved, whereby the amplitudes of the individual excitation vibrations can be reduced and the risk of damage to target structures is thus decreased.

In this case, the excitation frequencies of the plurality of excitation vibrations preferably do not have a rational relationship between each other. Thus, the quotient of the excitation frequencies is preferably an irrational number so that excitation of the same resonance vibration by several excitation frequencies is avoided.

In a further embodiment variant of the invention, several actuators can be coupled to the object and can introduce several excitation vibrations with essentially the same excitation frequencies into the object. In this case, the excitation vibrations can preferably overlap each other structurally at the location of the supporting structure to form the resonance vibration in the vibration system, whereby an increase in the amplitude of the resonance vibration can be achieved in a simple manner in the vibration system and the release of the connection can be further facilitated. In one embodiment of the invention, at least one actuator is attached to the base plate of the object and the actuators attached to the first element and to the base plate have the same or a similar excitation frequency, with similar excitation frequencies differing from each other by 10% at most, based on the smaller excitation frequency. The excitation by the actuators should take place synchronously, i.e., with the same or a similar phase position, with a similar phase position implying a phase difference of 15° at most.

If the actuators are moreover coupled to the object at different locations, the reliability of the method can be further increased. Especially if the phase shift of the excitation vibrations introduced into the object is adjusted in such a way that the excitation vibrations at the location of the supporting structure have the same phase and thus overlap each other structurally. The excitation of other structures or elements in the object can thereby be avoided, since the excitation vibrations overlap each other structurally only at points of a matching phase and cancel each other out or weaken each other in the remaining area of the object.

According to a further embodiment variant of the invention, at least one actuator is attached to a supporting structure of the object. By attaching this actuator directly to a supporting structure of the object, the efficiency of the coupling between the actuator and the object and the introduction of the excitation vibrations into the vibration system can be improved.

In a preferred embodiment of the present invention, the at least one mechanical actuator is mechanically coupled right to or, respectively, directly to the object, i.e., the mechanical coupling between the actuator and the object does not occur via a fluid as an indirect vibration transmitter. By introducing the mechanical vibrations directly into the object via the actuator, unfavourable damping possibly caused by a fluid can be avoided, and the vibration quality can thus be significantly increased.

In a further preferred embodiment variant, the object can be kept freely suspended or free-floating during the method. In this way, damping components in the vibration system and an outflow of vibration energy from the supporting structure into the damping can be avoided. Such a free suspension can be accomplished, for example, by decoupling the object via elastic buffers, air cushions, etc. or via the suspension by means of springs, ropes or the like. Similarly, it is conceivable that the object is kept magnetically floating, for example. In this case, the suspension can preferably be designed in such a way that the resonance frequencies of the suspension itself are at a sufficient distance from the resonance frequencies of the vibration system of the supporting structure and no resonant excitation of the suspension will thus occur due to the excitation vibration. The achievable quality of the resonance vibration in the vibration system can thus be at least 100, preferably at least 1,000, particularly preferably at least 10,000.

Furthermore, if the actuators are connected to a control device via electric lines, these electric lines can be designed such that they add only very little damping to the suspension. For this purpose, the electric lines can consist, for example, of very thin wires made of flexible strands (e.g., braided strands), or in a further embodiment variant, the control device can be provided directly together with the actuators. Furthermore, the control and the actuators could be provided with wireless energy supplies (e.g., using batteries) so that electric lines toward the outside, which exert additional damping on the suspension, are not required. In yet another embodiment variant, the control can communicate wirelessly with the actuators (e.g., via radio, via wireless network, via optical signal transmission or the like).

In a further embodiment variant, a mechanical impulse can be introduced into the base plate or the supporting structure in addition to exciting the vibration system with the at least one resonance vibration. While the resonance vibration is, on the one hand, excited via the excitation vibration, the mechanical impulse can also couple into the resonance vibration and temporarily increase its amplitude. The impulse can, for example, be coupled into the object by means of a short, hard blow and can excite a wide frequency range with high amplitude there. In doing so, the deflection of the supporting structure can exceed the breaking point in the connection and can thus cause the connection to be suddenly released.

According to an embodiment variant of the invention, the resonance frequency of the resonance vibration can be determined and the excitation frequency of the excitation vibration can be adjusted as a function of the determined resonance frequency, in particular in a control loop (control circuit). Through continuous resonant excitation of the vibration system of the supporting structure or, respectively, the connection to be released, this connection can harden as a result of the vibrations. The progressive hardening of the connection leads to a constant shift in the resonance frequency of the associated resonance vibration, whereby the excitation vibration has to be tracked so as to ensure a resonant excitation of the resonance vibration until the connection is released. In this way, it can be prevented in particular that, due to the shifting of the resonance frequencies, the excitation frequency resonantly excites target-structure vibration systems instead of the supporting-structure vibration system, thereby damaging or destroying target structures.

The resonance frequency of at least one resonance vibration of the vibration system can thereby be determined continuously, for example, in that a frequency sweep is introduced as an excitation vibration into the vibration system via the actuators and the frequency response is measured via sensors. After the resonance frequency of the resonance vibration has been determined, the excitation frequency can then be set to the determined resonance frequency and the method can again be continued with the introduction of the excitation vibration into the supporting structure. As a result, an excitation as efficient as possible of the resonance vibration of the vibration system can always be ensured in order to ensure a release as specific as possible of the at least one connection between the supporting structure and the first and second elements. The determination of the resonance frequency and the subsequent adjustment of the excitation vibration can preferably take place continuously in a control loop so that the method can react directly to changes or, respectively, shifts in the resonance frequency.

In a particular embodiment variant of the invention, a phase-locked loop (PLL) can, in this case, be used as the control loop. The phase of the excitation vibration is thereby always adapted to the phase of the resonance vibration and is tracked accordingly. If the phases of the excitation and resonance vibrations match, the excitation frequency also corresponds to the resonance frequency.

In one embodiment variant, the excitation vibration can be introduced into the supporting-structure vibration system as a continuous sine wave with a specific excitation frequency. As a result, a targeted excitation of specific resonance vibrations can indeed be achieved, but the excitation frequency must be tracked if there are shifts in the resonance frequency in order to still achieve an excitation of the desired structure.

In a further embodiment variant, the excitation vibration can also have a pulsed sine wave. Due to the sine pulse which is limited in time, the site-selectivity of the resonant excitation of the resonance vibration can be significantly increased, particularly if several actuators are used simultaneously. By parallel emission of wave packets from several actuators, which overlap each other in phase and simultaneously at the location of the supporting structure, the vibrational energy can advantageously be introduced exclusively into the supporting-structure vibration system. In addition, the risk of damage to target structures is drastically reduced. A particularly efficient and reliable method of removing supporting structures can thus be provided.

According to a further embodiment variant, the excitation vibration can also exhibit tape noise. Such tape noise can appear, for example, in the frequency range as a Gaussian curve with a mean value at the nominal excitation frequency. The full width at half maximum (FWHM) of the Gaussian curve or, respectively, the normal distribution determines, in this case, the width of the tape noise. In case of a third noise, the width corresponds, for example, to a third of the excitation frequency or, respectively, the mean value. The use of tape noise as an excitation vibration can be characterized in particular by a lower susceptibility to frequency shifts of the resonance vibration. Thus, in case of, e.g., a shift by the full width at half maximum, an excitation with half the maximum excitation amplitude can still occur.

According to yet another embodiment variant, the excitation vibration can have a frequency sweep. In the context of the present invention, a frequency sweep is understood to be a vibration with a frequency that changes over time, wherein the change in frequency can occur, for example, linearly (linear frequency sweep), quadratically, logarithmically or the like. By using a frequency sweep as an excitation vibration, a temporal change in the resonance frequency can be followed, in particular without any further control technology, with the excitation frequency rising or falling continuously in accordance with the frequency sweep. Thus, for example, by calculating or simulating the predicted frequency curve of the resonance vibration of the supporting structure, which results, for example, from a hardening of the connection to be released, and a corresponding superposition of the predicted frequency curve with the frequency sweep, the excitation frequency can always be kept in the vicinity of the resonance frequency. In this case, the frequency sweep can start at an initial frequency and can steadily change towards a final frequency.

The previously mentioned embodiment variants with regard to the excitation frequency can also be combined with each other as desired. For example, a linear frequency sweep can thus be combined with a continuous sine wave. However, the frequency sweep can similarly also be combined with a pulsed sine wave from several actuators, wherein all timed and phase-aligned pulsed sine waves are continuously changed in their excitation frequency in accordance with the frequency sweep. Similarly, it is also conceivable that the frequency sweep is combined with tape noise or with a pulsed sine wave with superimposed tape noise.

It is furthermore an object of the invention to make a device for removing supporting structures of the initially mentioned type more efficient and cost-effective.

The object is achieved by a device which comprises at least one mechanical actuator coupled to the 3-dimensional object in order to introduce a mechanical excitation vibration, the device having a control which is coupled to the at least one actuator and is programmed to control the excitation vibration and to excite the vibration system with at least one resonance vibration associated with it in such a way that the deflection of the resonance vibration exceeds the load limit at least at one point in the vibration system at least at one point in time, the first element of the object being a target structure or an intermediate plate and the second element being a base plate of the object. The device has a plurality of actuators connected to the control and mechanically coupled to the object, the control being programmed to introduce several excitation vibrations into the object, which overlap each other in the vibration system to form the resonance vibration, with at least one of the actuators being coupled to the first element.

In this case, the actuator can preferably be coupled directly to the object so that the mechanical excitation vibration can be supplied from the actuator directly to the vibration system in order to excite the resonance vibration. The control of the device is programmed in such a way that in particular the frequency and/or the phase and/or the amplitude of the excitation vibration can be controlled. In this connection, it is always possible to ensure that the resonance vibration of the vibration system is excited, the resonance vibration being formed by a vibrational mode of the deformation vibration of the connection between the supporting structure and the first or second element of the object. In this case, the excitation vibration is controlled via the control in such a way that the deflection of this resonance vibration exceeds the load limit at a point in the vibration system at one point in time, in particular the load limit of the connection, and the connection is thus released according to the invention.

According to a further embodiment variant of the invention, the device can have a plurality of actuators connected to the control and mechanically coupled to the object. In this case, the control of the device is preferably programmed to simultaneously introduce several excitation vibrations into the object, which overlap each other in the vibration system to form the resonance vibration. As described above for the method according to the invention, such a superposition of the excitation vibrations can generate a resonance vibration with a very high amplitude at the location of the connection of the supporting structure that is to be released, the resonance vibration allowing the connection to be released more easily and reliably.

In an alternative embodiment, a single actuator is coupled to the first element in order to introduce a mechanical excitation vibration into the first element, by means of which the actuator sets the first element into resonance vibration, whereupon the actuator is controlled so as to change the excitation vibration to a counter-vibration, thereby promoting the breakage of the supporting structure.

According to an embodiment variant of the invention, the device can have a base plate to which the at least one actuator is rigidly connected and directly coupled. The object can be positioned on the base plate with the supporting structure to be removed, whereby a direct and efficient introduction of the excitation vibration into the vibration system is enabled. In a further embodiment of the invention, the base plate can likewise be used for the manufacture of the object. In this case, the object is manufactured directly on the base plate including the supporting structure using an additive manufacturing process (such as, e.g., 3D printing). By specifically controlling the actuator using the control of the device, the supporting structure can be removed in a targeted and efficient manner after manufacture, without any further preparatory steps.

According to a further embodiment variant of the invention, the plurality of mechanical actuators can be arranged along at least one side of the base plate. The base plate preferably has a circumferential edge region and a central positioning region, the positioning region being designed for accommodating the object and the mechanical actuators being arranged in the edge region of the base plate. A device that can be used in a particularly versatile and flexible manner can thus be provided.

In a further embodiment variant, the mechanical actuators can be designed as piezo actuators, which are coupled to the object in a non-positive way. Piezo actuators can be particularly suitable for introducing higher-frequency excitation vibrations into the object.

In yet another embodiment variant, the mechanical actuators can be designed as electrodynamic actuators, which comprise a mass oscillating in an electrodynamically linear way. In this case, the electrodynamic actuator can be designed similarly to a loudspeaker or a bass shaker (structure-borne sound transducer) for the generation of low-frequency vibrations. In addition, such actuators as well as piezo actuators are able to emit several frequencies simultaneously, largely independently of each other.

In yet another embodiment variant, the mechanical actuators can be designed as electrodynamic actuators, which comprise an electrodynamically rotatable mass and/or unbalance. Via the rotatable mass or, respectively, unbalance, an excitation vibration is, in turn, introduced into the object that is coupled thereto in a non-positive way. Such electrodynamic actuators are particularly suitable for introducing medium to low-frequency excitation vibrations into the object with particularly high efficiency.

In a further embodiment variant, the device can comprise a pulse generator. Such a pulse generator can exert an additional excitation on the object by means of a hard blow with high impulse, which additional excitation can contribute, in addition to the excitation vibration, to a sudden release of the connection.

According to one embodiment variant, the control comprises a measuring device for measuring the resonance frequency of the resonance vibration and a control device for regulating the excitation frequency of the at least one excitation vibration. In this case, the measuring device is connected to the control device, and the control device is configured for adjusting the excitation frequency as a function of the resonance frequency. The device can thus react reliably to changes in the resonance frequency, which are due, for example, to a hardening of the connection to be released as a consequence of the excitation, and can adjust the excitation frequency of the excitation vibration accordingly.

In one variant, the control device can have a control loop, which can be designed, for example, as a phase-locked loop (PLL). The control loop or, respectively, the phase-locked loop can reliably adjust the excitation vibration in such a way that it always essentially corresponds to the resonance frequency.

Furthermore, the control of the device is preferably programmed to implement the method according to the invention.

It is furthermore an object of the invention to provide a method for the production of an object by means of additive manufacturing of the initially mentioned type which enables the reliable production of an object using supporting structures and the subsequent removal of these supporting structures.

The invention achieves the object that has been presented in that the supporting structure is configured during additive manufacturing in such a way that a vibration system consisting of the first and second elements and the supporting structure is formed, the vibration system having at least one resonance vibration in relation to the supporting structure, the predetermined resonance frequency of which is lower than the resonance frequencies of resonance vibrations in relation to the first or second element.

If the vibration system has a resonance vibration the resonance frequency of which is lower than the resonance frequencies in relation to resonance vibrations of the first or second element, a resonant excitation of structures other than those to be removed can be reliably avoided. In this connection, it can be ensured in particular that only the connection between the supporting structure to be removed and the first or second element is released by resonant excitation and that the remaining target structures of the object are not damaged.

Preferably, the predetermined resonance frequency of the resonance vibration in relation to the supporting structure is, in this case, lower than the resonance frequencies in relation to the first or second element. Because of the lower frequency, the probability of a resonant excitation of other target structures in the object is further reduced. In particular, the predetermined resonance frequency is by one predetermined tolerance range below the resonance frequencies in relation to the first or second element, since especially through resonant excitation of the supporting structure or, respectively, the connection, the resonance frequency thereof may increase due to hardening, as a result of which the distance from the resonance frequencies of the target structures decreases, but the resonance frequency continues to lie within the tolerance range. A particularly reliable method for the production of objects can thus be provided.

According to a further embodiment variant of the invention, a support can be provided between the first element and a further element or between the second element and a further element of the object. Preferably, the support can thereby further increase the resonance frequencies of the resonance vibrations in relation to the first element or, respectively, in relation to the second element, thus further increasing their distance from the resonance frequency in relation to the supporting structure.

In one embodiment variant, the at least one supporting structure can be designed such that its connection to the first and/or second element exhibits a predetermined breaking point. If a predetermined breaking point is provided in a connection, i.e., at the transition from the supporting structure to the first or second element, on the one hand, the associated resonance frequency can be further reduced and, on the other hand, a weak point with a low load limit or, respectively, with a low breaking limit can be installed, at which the connection fails and becomes detached already upon excitation with low resonance vibration amplitudes.

In this case, the predetermined breaking point can be designed, for example, in the form of a cross-sectional taper and/or a sharp edge. A cross-sectional taper can be formed, for example, by an hourglass shape or can, for example, have a cone shape the tip of which constitutes the cross-sectional taper. Alternatively, the predetermined breaking point can also be formed by an edge, which can facilitate a release of the connection.

In a preferred embodiment variant, the resonance vibrations of the elements without supporting structures can be determined based on the object to be produced, and the supporting structure can be designed in such a way that the at least one resonance vibration of the supporting-structure vibration system has a resonance frequency in relation to the supporting structure which is lower than the lowest resonance frequency of the resonance vibrations of the elements of the object without supporting structures.

In one embodiment variant, such a determination of the resonance vibrations or, respectively, the associated resonance frequencies of the elements of the object without supporting structures can be conducted, for example, via computer simulation or a calculation based on the design drawings and data. Using computer simulation or, respectively, a calculation, a Fourier analysis of all frequencies in the object can thereby be performed.

In an alternative embodiment variant, the determination of the resonance vibrations or, respectively, the associated resonance frequencies of the elements of the object without supporting structures can be conducted by measuring the resonance frequencies on a prototype. In doing so, a prototype with generic supporting structures can be manufactured, for example, and the supporting structures can subsequently be removed by hand. The resonance response of the object can then be determined by recording using a sensor when the object is excited, for example, with a frequency sweep. The resonance spectrum in the frequency space can be determined from the resonance response using a Fourier analysis.

Based on the obtained resonance spectrum of the object without supporting structures, the supporting structure can now be designed and configured in such a way that its resonance frequency lies below all resonance frequencies in the determined resonance spectrum of the object.

In a further embodiment variant, several supporting structures can be provided in several supporting-structure vibration systems in the object, and the resonance frequencies of the at least one resonance vibration of the supporting-structure vibration system in relation to the respective supporting structure can jointly form a frequency band. If several supporting structures are provided which are designed in such a way that their resonance frequencies jointly form a frequency band, the reliability of the method can be further improved. The resonance frequencies in the frequency band can, for example, be resonantly excited jointly by excitation using an excitation frequency so that the method can be accelerated significantly. Advantageously, the supporting structures can furthermore be designed in such a way that their resonance frequencies all lie in the frequency band below the resonance frequencies of the target structures. The risk of damage to target structures can thereby be further reduced.

According to a preferred embodiment variant of the invention, a method according to any of claims 1 to 11 is performed in order to release the at least one connection and remove the supporting structure following the additive manufacturing of the object.

### SHORT DESCRIPTION OF THE FIGURES

Preferred embodiment variants of the invention are illustrated in further detail below with reference to the figures. The following is shown:

FIG. 1 shows a schematic top view of a device for removing a supporting structure from an object according to a first embodiment variant,

FIG. 2 shows a schematic top view of a device according to a second embodiment variant,

FIG. 3a shows a schematic cross-sectional view of a supporting structure according to a first embodiment variant,

FIG. 3b shows a schematic cross-sectional view of a supporting structure according to a second embodiment variant,

FIG. 4a shows a schematic cross-sectional view of a supporting structure according to a third embodiment variant,

FIG. 4b shows a schematic cross-sectional view of a supporting structure according to a fourth embodiment variant,

FIG. 5a shows a schematic cross-sectional view of a supporting structure according to a fifth embodiment variant,

FIG. 5b shows a schematic cross-sectional view of a supporting structure according to a sixth embodiment variant,

FIG. 6 shows a schematic cross-sectional view of a vibration system with two supporting structures according to a seventh embodiment variant, and

FIG. 7 shows a schematic cross-sectional view of a vibration system with a plurality of supporting structures according to further embodiment variants.

### METHODS OF IMPLEMENTING THE INVENTION

The embodiment variants of the invention described specifically below are to be regarded merely as exemplary embodiment variants and are not to be regarded as limiting the scope of protection as defined according to the claims.

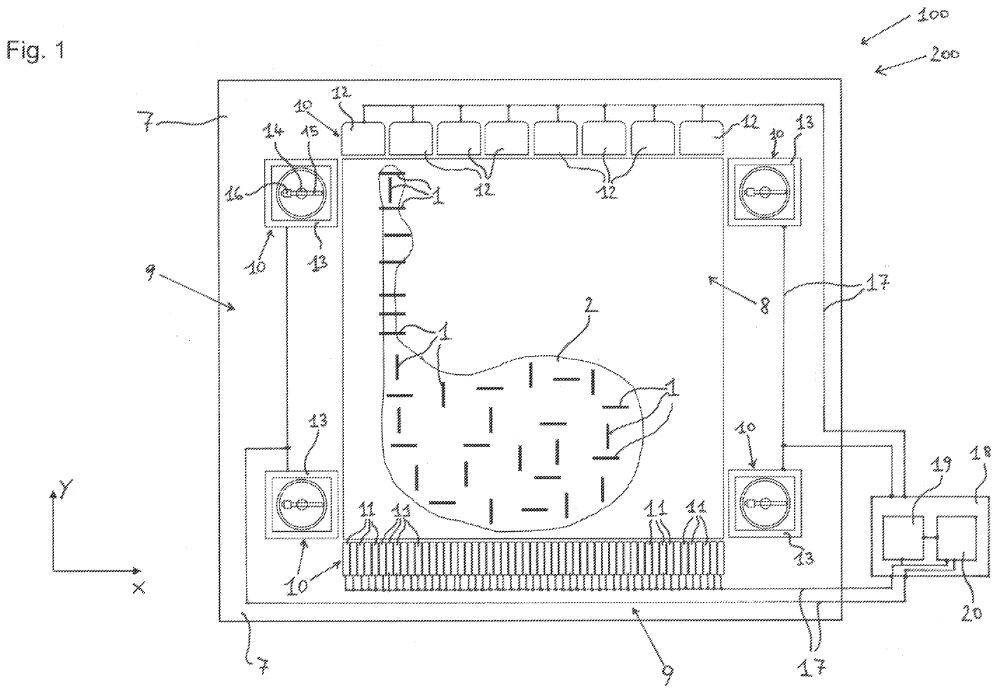

In FIG. 1, a device 100 for removing supporting structures 1 from an object 2 according to a first embodiment variant is shown. Using the device 100, a method 200 of removing the supporting structures 1 from the object 2 can be performed according to the invention. Specific configurations of the method 200 emerge from the following description.

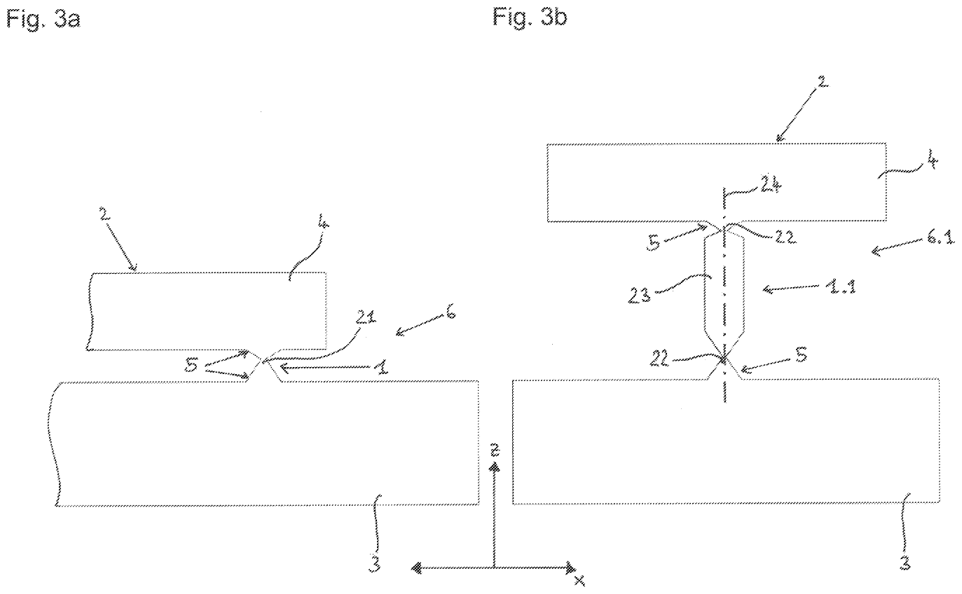

In this case, the object 2 is produced by an additive manufacturing process, with at least one supporting structure 1 being provided in the object 2 between a first element 3 and a second element 4 of the object 2. The supporting structure 1 exhibits, in each case, at least one connection 5 with the first element 3 and with the second element 4 and, together with them, forms a vibration system 6. Such vibration systems 6, 6.1, 6.2, 6.3, 6.4, 6.5, 6.6, 6.7 (6, 6.1-6.7) comprising supporting structures 1, 1.1, 1.2, 1.3, 1.4, 1.5, 1.6, 1.7, 1.8, 1.9, 1.10, 1.11, 1.12, 1.13 (1, 1.1-1.13) between a first and a second element 3, 4 are depicted in detail in FIGS. 3a, 3b and 4-7. A detailed description of the aforementioned figures is given below.

In this case, the device 100 according to FIG. 1 comprises a base plate 7 on which the object 2 is provided in a central positioning region 8 and is mechanically coupled to the base plate 7.

The first element 3 and/or the second element 4 of the object 2 can optionally be a target structure (i.e., a structure that should not be removed), or else the base plate 7 itself on which the object 2 is provided.

The object 2 is an object 2 which has been produced by an additive manufacturing process, i.e., for example, by 3D printing or the like. In this case, the object 2 can optionally be provided in the positioning region 8 of the base plate 7 after production, or can be manufactured directly in the positioning region 8 of the base plate 7, whereby the base plate 7 can be considered as part of the object 2. Thus, in one embodiment variant, the base plate 7 can, for example, form the first element 3 of the object 2 itself. Upon completion of the method 200, i.e., after removal of the supporting structures 2, the object 2 can be removed or detached from the base plate 7.

In FIG. 1, the object 2 is depicted as a transparent contour with a plurality of supporting structures 1, wherein the supporting structures 1 can, in this case, be provided at any location within the object 2.

In a circumferential edge region 9 of the base plate 7, the device 100 comprises several actuators 10 which are mechanically coupled to the base plate 7 and can thus introduce mechanical excitation vibrations into the object 2.

In this case, the device 100 comprises an array of piezo actuators 11 in its lower edge region 9 of the base plate 7. Depending on the actuation, the piezo actuators 11 can thereby be used optionally as actuators 10 for introducing mechanical vibrations or as sensors for measuring the resonance behaviour or, respectively, the resonance response of the object 2.

Furthermore, the device 100 comprises a series consisting of eight electrodynamic actuators 12 in its upper edge region 9 of the base plate 7. Such electrodynamic actuators 12 (also referred to as “shakers”) can likewise be used for the introduction of (predominantly low- to medium-frequency) excitation vibrations into the object 2. In one embodiment variant, the individual actuators 12 can thereby generate excitation vibrations with different excitation frequencies independently of each other. In a further embodiment variant, the actuators 12 can also be actuated jointly in order to generate a single excitation vibration with a specific excitation frequency.

Furthermore, on the base plate 7 in the left and right edge regions 9, two unbalance actuators 13 are, in each case, arranged, which can introduce particularly low-frequency vibrations with high amplitude into the object 2. In this case, the unbalance actuators 13 each have an electric motor (in particular a servo motor with position detection), on the shaft 14 of which a crossbeam 15 is attached, which has been exemplified for the upper left actuator 13. On this crossbeam 15, an unbalance weight 16 is provided which is preferably mounted so as to be displaceable along the crossbeam 15. Preferably, the crossbeam 15 can thereby be set in rotation and, after a predetermined target speed has been reached, the unbalance weight 16 can be shifted toward the outside so that a mechanical vibration is coupled into the base plate 7 due to the unbalance. By quickly reaching the speed and generating the unbalance later, excitation of undesirable frequencies is further prevented.

In doing so, the different actuators 10 have different frequency bands in which they operate particularly advantageously. Thus, unbalance actuators 13 are preferably suitable for excitations of approximately 0-400 Hz, linear electrodynamic actuators 12 are preferably suitable for excitations of approximately 3-2000 Hz, and piezo actuators 11 are preferably suitable for excitations of approximately 1 kHz-5 MHz.

In a further embodiment variant, which is not illustrated in further detail in the figures, pulse generators can also be coupled to the base plate 7 in order to introduce a short, high impulse into the object 2, thus facilitating a sudden release of the connections 5 between the supporting structure 1 and the first or, respectively, second element 3, 4.

As further shown in FIG. 1, the actuators 10 are connected to a control 18 via lines 17 (in particular bus lines). Particularly in the case of bus lines as lines 17, each actuator 10 can be separated from the control 18 and can be actuated independently. In this case, the control 18 is programmed such that a desired excitation vibration with a predetermined excitation frequency is introduced into the object 2 and the vibration system 6 of the supporting structure 1 is excited there with a resonance vibration associated with it. In doing so, the introduction of the excitation vibrations occurs via appropriate actuation of the actuators 10.

The control 18 is programmed in particular to implement the method 200 described according to the embodiment variant.

The control 18 is furthermore designed and programmed such that the piezo actuators 11 can also be used as piezo sensors. In doing so, the control 18 can switch arbitrarily between the operating modes as an actuator 10 and as a sensor. Thus, part of the piezo actuators 11 can optionally also be used as sensors.

As illustrated in FIG. 1, the piezo actuators 11 are arranged equidistantly in a row along the entire side of the positioning region 8 of the base plate 7. By actuating the piezo actuators 11 in parallel for the emission of vibrations with the same phase, a parallel wave front can be emitted and the resonance behaviour of the object 2 can be determined by measuring the vibration response using piezo sensors. The device 100 can thus be used for locating resonators in the object 2 and for determining their resonance frequency. In the sensor mode, the piezo actuators 11 can record and analyse vibrations very precisely according to location, frequency and amplitude. If the excitation is known, the vibration properties, such as, e.g., the vibration quality, the resonance frequency and the directions of the vibration modes, can thereby be determined for each location on the base plate 7.

The electrodynamic actuators 12 and the unbalance actuators 13 can also be used by the control 18 for the emission of excitation vibrations with predetermined excitation frequencies.

As part of the method 200, a mechanical excitation vibration is thus generated and introduced into the object 2 by means of the actuators 10, which are connected to the base plate 7 and are thus mechanically coupled to the object 2. The mechanical excitation vibration is supplied to the vibration system 6 consisting of the supporting structure 1 and the first and second elements 3, 4, as well as the connections 5 between them, whereby the vibration system 6 is excited with an associated resonance vibration. Due to the deflection of the resonance vibration, the load limit is exceeded particularly at the location of the connection 5 between the supporting structure 1 and the first or second element 3, 4, and the respective connection 5 is released.

By emitting the excitation vibration from the actuators 10 and exciting a resonance vibration of the vibration system 6, the deflection of the resonance vibration and thus of the connection 5 can, at one point in time, exceed the load limit at least at one point, with the connection 5 being released. In this case, the load limit is in particular the breaking limit in the connection 5.

In this case, the resonance vibration associated with the vibration system 6 corresponds to the excitation of at least one normal mode of the vibration system 6. The normal modes of the vibration system 6 which are to be excited preferably in the process constitute notably deformation vibrations of the supporting structure 1.

In a preferred embodiment variant, as indicated schematically in FIG. 1, the control 18 comprises a measuring device 19 designed for measuring the resonance frequency of the resonance vibration. In addition, the control 18 comprises a control device 20 designed for regulating the excitation frequency of the at least one excitation vibration. The measuring device 19 can, in this case, use the signals from the piezo actuators 11 for measuring the resonance frequencies, while the control device 20 actuates the actuators 10 for the generation of the excitation vibration with an excitation frequency determined by the control device 20. The measuring device 19 is connected to the control device 20, and the control device 20 is configured for adjusting the excitation frequency as a function of the resonance frequency determined by the measuring device 19. According to one embodiment variant, the control device 20 can be designed as a control loop (PID) or as a phase-locked loop (PLL) especially for tracking changes in resonance frequency in the excitation frequency.

The signal shape of the excitation vibration can be determined by the control 18 as a function of the supporting structures 1 to be removed or, respectively, to be excited. For example, the excitation vibration can thus have a continuous sine wave at a predetermined excitation frequency in order to achieve cyclic excitation and charging of the resonance vibration. Similarly, the excitation vibration can have a pulsed sine wave or tape noise or even a frequency sweep. By means of such signal shapes or, respectively, any combinations thereof, excitation and measurement of the resonance vibrations can occur simultaneously, for example.

The method 200 can take place, for example, in several passes according to the object 2 in FIG. 1. Thus, in a first pass, the supporting structures 1, which are shown vertically, are broken off, wherein the supporting structures 1, which are depicted horizontally, remain connected to the object 2, holding or, respectively, stabilizing it. In a second pass, the supporting structures 1 still remaining, which are depicted horizontally, are then broken off.

During the implementation of the method 200, the device 100 hangs at four suspension points on the base plate 7, in particular at the corners thereof, which, however, has not been illustrated in further detail in the figures. The suspension thus consists of 4 thin elastic ropes or cords (e.g., made of an elastomer). In a preferred case, the resonance frequency of the suspension can, in this case, be less than 1 Hz, preferably less than 0.5 Hz, particularly preferably less than 0.25 Hz. In this case, the length or, respectively, tension of the suspension can be adjusted additionally by motorized adjustable winches in order to keep the device 100 horizontal.

According to a further embodiment variant, the entire device 100 is located in an evacuable chamber, which, however, is not shown either in the figures. If necessary, the quality of the resonance vibrations can thus be increased by reducing the air friction. In this case, the actuators 10 are preferably designed for use in a vacuum. In an alternative embodiment variant, the chamber can be filled with a suitable gas, for example, in order to simultaneously optimize the quality of the resonance vibrations and the heat dissipation capacity of the actuators 10. For this purpose, for example, a gas combining good thermal conductivity with low viscosity is used at a pressure (e.g., helium at less than atmospheric pressure).

In alternative embodiment variants, which have not been illustrated in further detail in the figures, the object 2 can be kept freely suspended or free-floating during the method 200 also without a device 100 being used. In this case, the actuators 10 can be attached directly to an element 3, 4 or to a supporting structure 1 of the object 2. The previously described embodiments of the method 200 can thereby be implemented accordingly.

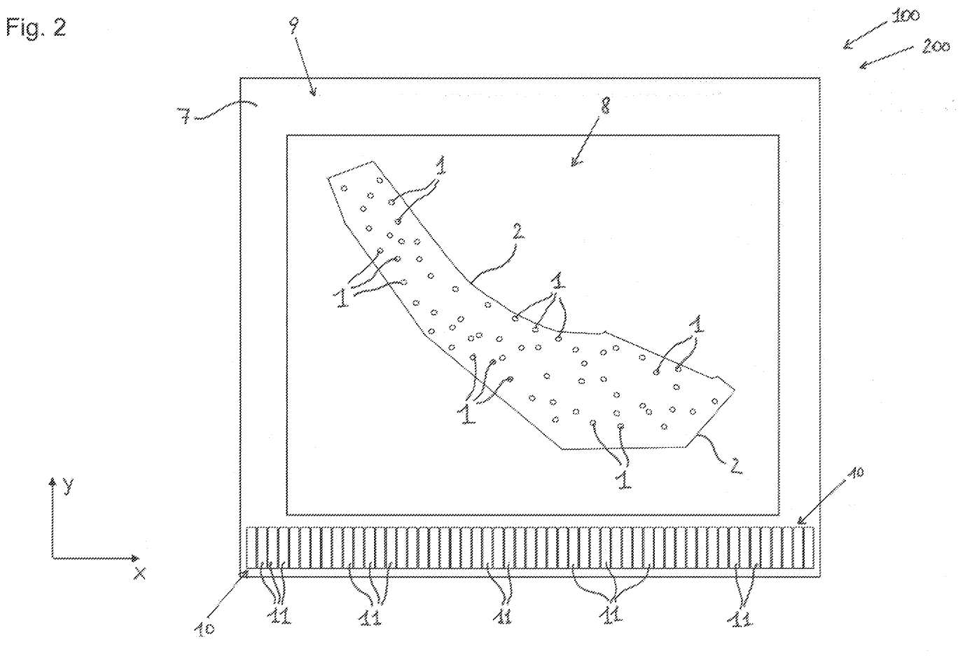

FIG. 2 shows a second embodiment variant of a device 101 according to the invention for performing the method 200. In this case, the device 101 is suitable for the removal of supporting structures 1 from an object 2 (in particular with particularly delicate target structures) which is immersed in a liquid. For this purpose, the device 101 comprises a base plate 7 on which the object 2 is provided in a positioning region 8. In an edge region 9 of the base plate 7, actuators 10, in particular piezo actuators 11, are, in turn, arranged along one side of the base plate 7.

The actuators 10 or, respectively, the piezo actuators 11 are, in turn, connected to a control 18 via lines 17, which, however, has not been illustrated in FIG. 2 for the sake of simplicity. For the configuration of the control 18, reference is made to the above description with regard to FIG. 1.

In this case, the device 101 furthermore has vessel walls which keep the liquid within the device 101, which, however, is not depicted in further detail in the figures. The device 101 is evacuated to a pressure slightly above the vapour pressure of the liquid to be used and is then filled with the liquid which covers the object 2. Afterwards, the device 101 is ventilated again, with the cavities of the object 2 being filled with the liquid and the incorporation of air bubbles being avoided.

In a further embodiment variant, the liquid might not completely cover the object 2. Preferably, the supporting structures to be removed can also protrude from the liquid in order to keep the quality of the resonance vibrations of the vibration system high.

Thereupon, a plane wave (with infinite focal length) is sent off in one direction by appropriately actuating all piezo actuators 11, and after the wave has been emitted, the piezo actuators 11 are switched as sensors. The resonance response to the excitation with the plane wave is recorded by means of the sensors. Subsequently, a plurality of waves can be emitted in further directions, and the above-described steps can optionally be repeated with different focal lengths. In this way, a sonographic image of the supporting structures 1 in the object 2 can be gathered. Furthermore, the vibration quality of the supporting structures 1 can also be determined (in the course of this or in a separate step).

The removal of the supporting structures 1 can be performed according to a method 200, as it has already been described for FIG. 1.

In case of the device 101, in which the supporting structures 1 are immersed in a liquid, the supporting structures 1 are preferably designed so as to be as fine or, respectively, delicate as possible, as permitted by the manufacturing process. Easy release of the connections 5 can thus be enabled despite the reduced quality of the resonance vibrations.

In FIGS. 3a, 3b and 4-7, schematic cross-sectional views of vibration systems 6, 6.1-6.7 with different supporting structures 1, 1.1-1.13 according to different embodiment variants are illustrated.

In this case, the supporting structures 1, 1.1-1.13 can be adjusted or, respectively, manufactured as part of a method 300 for the production of an object 2 in such a way that their resonance frequency in relation to the vibration system 6 is lower than the resonance frequencies of resonance vibrations in relation to the first or second element 3, 4.

In FIG. 3a, a vibration system 6 with a supporting structure 1 according to a first embodiment variant is illustrated. In this case, the supporting structure 1 includes only one predetermined breaking point 21, which is provided between the connections 5 to the first and second elements 3, 4.

In FIG. 3b, a vibration system 6.1 with a supporting structure 1.1 according to a second embodiment variant is illustrated. In this case, the supporting structure 1.1 includes two constrictions 22, which constitute solid joints and/or predetermined breaking points 21, and, in between, a leg 23, which allows the resonance motion and deflection of the supporting structure 1.1 between the target structures 3, 4, which can lead to a release of the connections 5.

In this case, both supporting structures 1 and 1.1 are designed to be rotationally symmetrical about the z-axis. At the constrictions 22, the leg 23 is thus rotatable along an axis of rotation 24 in the z-direction, and it is also linearly deflectable along the horizontal axes (x, y).

If the supporting structures 1 or 1.1, respectively, are arranged next to each other multiple times (for example, for the support of a wide area), the use of the supporting structure 1 (according to FIG. 3a) leads to a relatively stiff connection, while the use of the supporting structure 1.1 (according to FIG. 3b) allows mobility in the horizontal plane. Excitation energy can thus be collected in the entire vibration system 6.1 across several vibrations, with the collected energy leading to a high deflection and thus causing the connections 5 to break or, respectively, to be released and, consequently, the target structures 3, 4 to be unlocked. The design of the supporting structure 1.1 can thus contribute to it being removed in an easier and reliable manner.

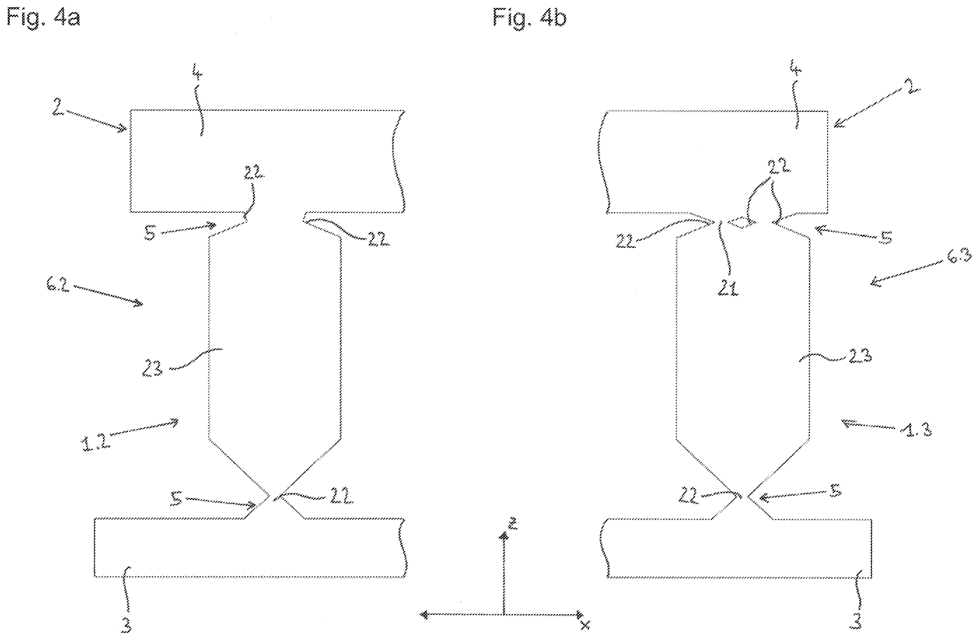

According to FIG. 4a, a vibration system 6.2 with a supporting structure 1.2 according to a third embodiment variant is illustrated, and, according to FIG. 4b, a vibration system 6.3 with a supporting structure 1.3 according to a fourth embodiment variant is illustrated.

In this case, the illustrated supporting structures 1.2, 1.3 are designed as plates extending along the y-direction. The supporting structures 1.2, 1.3 thus have constrictions 22 in their connection 5 to the first element 3, which are designed as grooves running along the y-axis on both sides of the supporting structures 1.2, 1.3.

At its upper connection 5 to the second element 4, the supporting structure 1.2 in FIG. 4a has a wider solid joint, which is also formed by a groove-shaped constriction 22 running along the y-axis. In this case, the vibration system 6.2 can be excited and enable a resonant deflection of the leg 23 only along the x-axis. Due to the high mass of the supporting structure 1.2 and the relatively stiff connection 5 to the second element 4, the resonance frequency in the vibration system 6.2 is significantly reduced.

The supporting structure 1.3 in FIG. 4b has an alternative predetermined breaking point 21 at its upper connection 5 to the second element 4. In this case, the predetermined breaking point 21 is formed by three constrictions 22 which are arranged one behind the other in the x-direction and again extend along the y-axis in the form of a groove. The central constriction 22 in thereby located inside the connection 5 or, respectively, the solid joint. As a result, a deflection of the leg 23 in the x-direction induces a rotation about the y-axis, which exerts a very large compressive or, respectively, tensile force on the predetermined breaking point 21, thus significantly facilitating a release of the connection 5.

A supporting structure 1.3 as illustrated in FIG. 4b is particularly suitable if a construction material of very high tenacity is used, in which case a constriction 22, in accordance with the supporting structure 1.2, cannot exert sufficient deflection or, respectively, force to exceed the breaking limit of the connection 5. Due to the inner constriction 22 in the supporting structure 1.3, the points of rotation can be moved out of the centre of the leg 23 along the y-direction and along the z-direction, and the lever acting on the predetermined breaking point 21 can thus be increased.

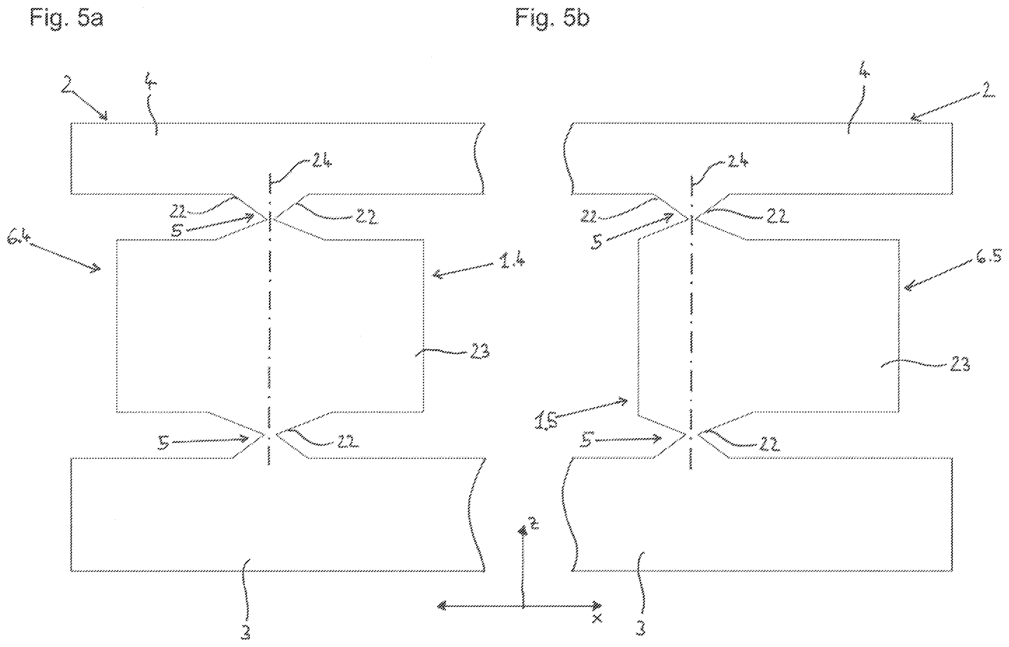

According to FIG. 5a, a vibration system 6.4 with a supporting structure 1.4 according to a fifth embodiment variant is illustrated, and, according to FIG. 5b, a vibration system 6.5 with a supporting structure 1.5 according to a sixth embodiment variant is illustrated.

With regard to its design, the supporting structure 1.4 in FIG. 5a is basically modelled after the supporting structure 1.1 shown in FIG. 3b. Thus, for a general description, reference is made to the above description with regard to FIG. 3b. However, the leg 23 is, in this case, significantly enlarged in its diameter, whereby the mass of the supporting structure 1.4 and the moment of inertia of the leg 23 about the z-axis are increased. On the one hand, the resonance frequency in the vibration system 6.4 is lowered due to the increased mass, and, on the other hand, the vibration system 6.4 can easily collect and store vibration energy because of the high inertia. The supporting structure 1.4 can thereby be broken off if its resonance vibration is excited, even in case of low amplitudes of the excitation vibration. In alternative embodiment variants, the leg 23 can also have a square, triangular, hexagonal or other cross-section.

The supporting structure 1.5 shown in FIG. 5b is again designed similarly to the previously described supporting structure 1.4, however, it is, in this case, deliberately designed so as to be asymmetrical. Linear excitation vibrations can thereby be converted into a rotational vibration (and vice versa if necessary). This is advantageous in many areas of application of the invention, since linear excitation vibrations can often be produced more easily by a device 100, 101 using the actuators 10.

In addition, in case of linear excitations, the sum of all accelerations at every point of the object 2 is (approximately) constant, while the acceleration during rotational movements depends on the distance from the point of rotation or, respectively, from the axis of rotation, which can lead to undesirable acceleration-related damage to target structures at exposed locations. By using linear excitations, a more reliable method 200 and 300, respectively, can be created.

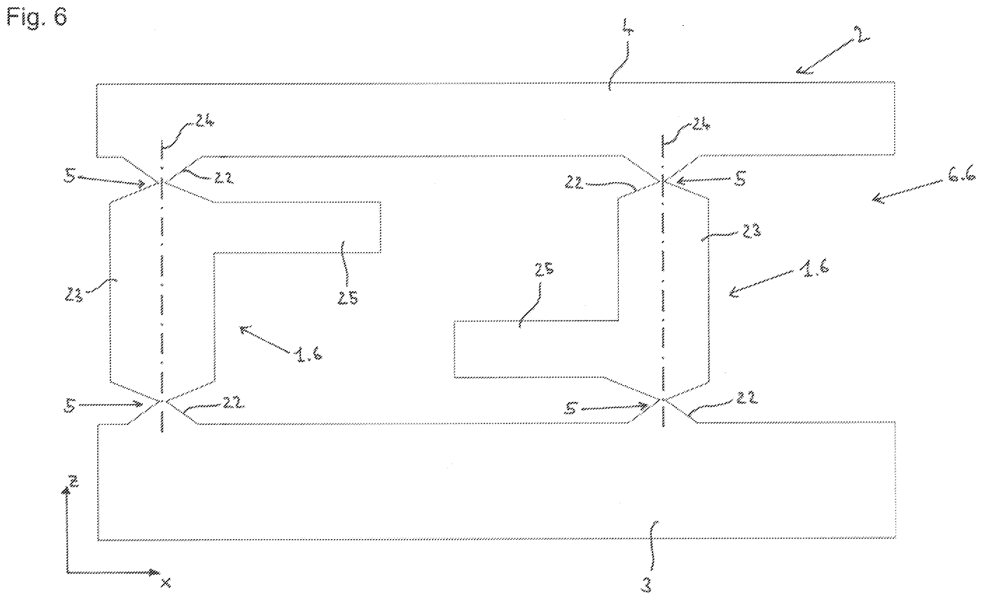

FIG. 6 shows a vibration system 6.6 with two supporting structures 1.6 according to a seventh embodiment variant of the invention. In this case, the supporting structures 1.6 are essentially designed comparably to the supporting structure 1.5 shown in FIG. 5b, for which reason reference is made to the general description in this regard. In contrast to the supporting structure 1.5, the legs 23 comprise cantilevers 25 along the x-direction in order to obtain an asymmetrical shape of the leg 23. By the cantilevers 25, a lever is generated which, when linearly excited in the y-direction, couples a strong rotational vibration of the supporting structures 1.6 into the vibration system 6.6 in the z-direction along the axis of rotation 24.

Through the rotational vibration (rotary pendulum movement), a heavy load on the constrictions 22 at the connections 5 is obtained, which can quickly lead to the connections 5 being torn off and released. The vibration system 6.6 thereby has at least two vibration modes for the respective rotation of the supporting structures 1.6. If the resonance vibrations of both vibration modes are simultaneously excited by one or several excitation vibrations, the supporting structures 1.6 can be removed essentially simultaneously.

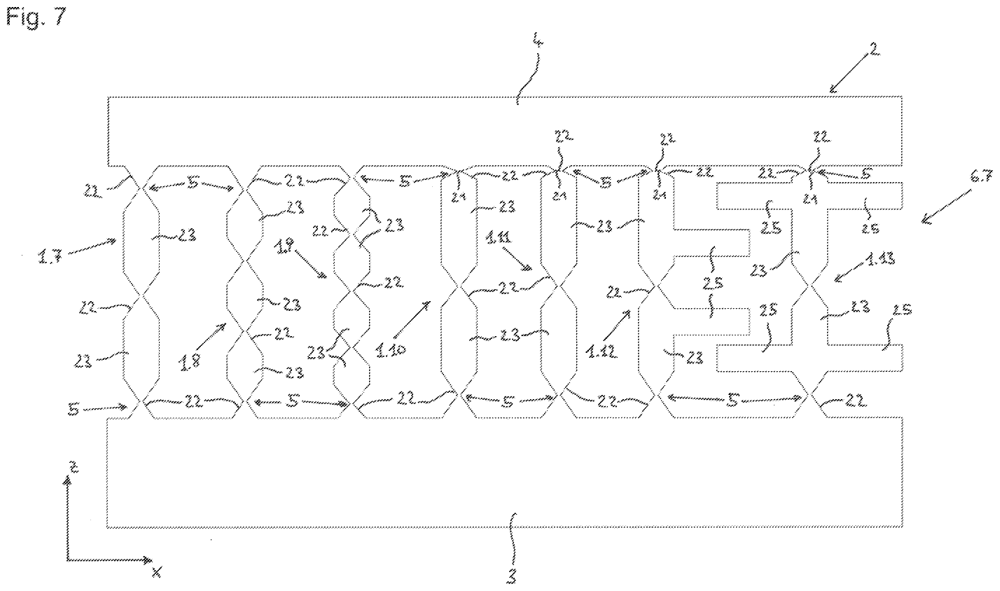

In FIG. 7, a vibration system 6.7 consisting of several supporting structures 1.7-1.13 is shown. In this case, the design of the supporting structures 1.7-1.13 is modelled after the supporting structures 1.2, 1.3 shown in FIG. 4a and FIG. 4b, which extend linearly (in a plate-shape manner) along the y-direction. For a general description of the supporting structures 1.7-1.13, reference is thus made to the description with regard to FIGS. 4a and 4b for the supporting structures 1.2, 1.3.

In this case, the supporting structure 1.7 has two legs 23 separated by a linear groove-shaped constriction 22. In case of a linear excitation in the x-direction, the legs 23 can be deflected into a rotational vibration relative to one another with an axis of rotation along the y-direction.

By contrast, the supporting structure 1.8 has three legs 23 which are arranged adjacent to each other and, in turn, are each separated by groove-shaped constrictions 22 along the y-axis. The supporting structure 1.8 can be excited with a higher resonance frequency compared to the supporting structure 1.7. The supporting structure 1.8 thereby generates at least two vibration modes, one of them corresponding to a diametrically opposed rotation of the legs 23 about the y-axis relative to each other and the other one corresponding to a uniform linear vibration of all three legs along the x-axis.

The supporting structure 1.9, in turn, constitutes a continuation of the principle from the supporting structures 1.7 and 1.8 and comprises four legs 23 connected to each other by constrictions 22. In this case, several vibration modes can again be generated, wherein the resonance frequency can be further increased.

This principle is particularly advantageous when removing supporting structures made of concrete. As they are being broken off, the supporting structures can thereby be broken into small, manageable blocks, which can be easily removed and reused or disposed of.

The supporting structure 1.10 differs from the supporting structure 1.7 in particular in that the constriction 22 at the upper connection 5 to the second element 4 differs from the other constrictions 22. The angle of the notch defining the constriction 22 and thus the predetermined breaking point 21 is more acute, whereby tearing and a release of the connection 5 are promoted at this point.

With regard to its design, the supporting structure 1.11 is closely modelled after the supporting structure 1.3 illustrated in FIG. 4b. In this case, the supporting structure 1.11 has an inner constriction 22 in the upper connection 5 to the second element 4, which enables a particularly favourable and simplified tearing behaviour at the predetermined breaking point 21 by a linear excitation vibration along the x-axis.

The supporting structure 1.12 combines in its design the features of the supporting structures 1.11 and 1.6 from FIG. 6. In this case, each of the two legs 23 comprises a cantilever 25. A mechanical resonator with particularly advantageous tearing properties at the predetermined breaking point is thus created, which, in addition to the rotational vibrations that can be excited about the z-axis, can also be excited by a linear excitation along the y-axis (or along the z-axis). These vibrations tend to first tear the predetermined breaking point 21 at an extreme point, i.e., at the beginning or at the end of the supporting structure 1.12 (along the y-axis), which further promotes the release of the connection 5 and thus enables an even gentler process.

The supporting structure 1.13 is ultimately based on the supporting structure 1.12, with the cantilevers 25 of the legs 23 being provided on both sides of the legs 23. The moment of inertia of the legs 23 is thus further increased both around the z-axis and around the y-axis. The release according to the invention of the connection 5 at the predetermined breaking point 21 can thereby be performed even more gently (with lower excitation amplitudes). However, excitation in the x-direction and along the z-axis is required for this.

1-13. (canceled)

14. A method of removing supporting structures from an object which has been produced by an additive manufacturing process and in which at least one supporting structure is provided between a first element and a second element of the object and has, in each case, at least one connection thereto and in which the supporting structure forms a vibration system together with the first and second elements,
wherein at least one of the connections is released by exciting the vibration system by mechanical vibrations,
wherein, using at least one actuator coupled to the object, at least one mechanical excitation vibration is introduced into the latter and is supplied to the vibration system, and the vibration system is excited with at least one resonance vibration associated with it in order to release the at least one connection, with the deflection of the resonance vibration exceeding the load limit at least at one point in the vibration system at least at one point in time,
wherein the first element is a target structure or an intermediate plate and the second element of the object is a base plate of the object and the at least one actuator is coupled to the first element.

15. The method according to claim 14, wherein the resonance vibration associated with the vibration system corresponds to the excitation of at least one normal mode of the vibration system.

16. The method according to claim 15, wherein the at least one normal mode of the vibration system is a deformation vibration of the supporting structure.

17. The method according to claim 14, wherein a single actuator is coupled to the first element and introduces a mechanical excitation vibration into the first element, by way of which the single actuator sets the first element into resonance vibration, whereupon the single actuator changes the excitation vibration to a counter-vibration, thereby promoting the breakage of the supporting structure.

18. The method according to claim 14, wherein several actuators are coupled to the first element and to the second element and introduce several mechanical excitation vibrations, the excitation vibrations overlapping each other in the vibration system to form the resonance vibration.

19. The method according to claim 18, wherein at least one actuator is attached to a supporting structure of the object.

20. The method according to claim 14, wherein at least one actuator is attached to the base plate of the object and the actuators attached to the first element and to the base plate have the same, or a similar, excitation frequency, with similar excitation frequencies differing from each other by 10% at most, based on the smaller excitation frequency.

21. The method according to claim 14, wherein a mechanical impulse is introduced into the base plate or the supporting structure in addition to exciting the vibration system with the at least one resonance vibration.

22. The method according to claim 14, wherein the object is kept freely suspended or free-floating during the method.

23. The method according to claim 14, wherein the resonance frequency of the resonance vibration is determined and the excitation frequency of the excitation vibration is adjusted as a function of the resonance frequency, in particular in a control device in a control loop.

24. The method according to claim 14, wherein the at least one excitation vibration has a pulsed sine wave and/or tape noise and/or a frequency sweep.

25. A device for removing supporting structures from an object, implementing the method according to claim 14,
wherein the object is an object produced by an additive manufacturing process and wherein at least one supporting structure is provided in the object between a first element and a second element of the object and has, in each case, at least one connection with the first element and the second element and, together with them, forms a vibration system, wherein the device comprises at least one mechanical actuator coupled to the object for the introduction of a mechanical excitation vibration,
wherein the device has a control which is coupled to the at least one actuator and is programmed to control the excitation vibration and to excite the vibration system with at least one resonance vibration associated with it in such a way that the deflection of the resonance vibration exceeds the load limit at least at one point in the vibration system at least at one point in time, and
wherein the first element is a target structure or an intermediate plate and the second element of the object is a base plate of the object, and the device has a plurality of actuators connected to the control and mechanically coupled to the object, the control being programmed to introduce several excitation vibrations into the object, which overlap each other in the vibration system to form the resonance vibration, with at least one of the actuators being coupled to the first element.

26. The device according to claim 25, wherein the control comprises a measuring device for measuring the resonance frequency of the resonance vibration and a control device for regulating the excitation frequency of the at least one excitation vibration, the measuring device being connected to the control device and the control device being configured for adjusting the excitation frequency as a function of the resonance frequency.
